(19) United States
(12) Patent Application Publication
(10) Pub. No.: US 2011/0068086 A1
(43) Pub. Date: Mar. 24, 2011

(54) PLASMA ETCHING METHOD

(75) Inventors: Takefumi Suzuki, Tokyo (JP); Azumi Ito, Tokyo (JP)

(73) Assignee: ZEON CORPORATION, Tokyo (JP)

(21) Appl. No.: 12/736,241

(22) PCT Filed: Mar. 27, 2009
(86) PCT No.: PCT/JP2009/056245

§ 371 Date: Dec. 2, 2010

(30) Foreign Application Priority Data
Mar. 31, 2008 (JP) 2008-091209

(51) Int. Cl. C03C 25/68

(52) U.S. Cl. 216/67

(57) ABSTRACT

A plasma etching method includes etching an etching target under plasma conditions using a process gas, the process gas including a saturated fluorohydrocarbon shown by the formula (1): CₓH_{y}F_{z}, wherein x is 3, 4, or 5, and y and z are individually positive integers, provided that y>z is satisfied. When etching a silicon nitride film that covers a silicon oxide film formed on the etching target, the silicon nitride film can be selectivity etched as compared with the silicon oxide film by utilizing the process gas including the specific fluorohydrocarbon under the plasma conditions.

### TECHNICAL FIELD

The present invention relates to a plasma etching method that etches an etching target under plasma conditions using a process gas that includes a specific fluorohydrocarbon.

### BACKGROUND ART

A process of forming a device on a wafer includes dry-etching a silicon nitride film (SiN film) that covers a silicon oxide film (SiO₂ film) (etching step).

A plasma etching apparatus is widely used for the etching step. An etching gas that selectively etches only the SiN film at a high etching rate without etching the SiO₂ film is desired as the process gas.

For example, CHF₃ gas and CH₂F₂ gas have been known as such an etching gas. Patent Document 1 discloses an etching gas that includes oxygen gas and a gas of a compound shown by CHₚF₄₋ₚ (p is 2 or 3; hereinafter the same) as a process gas that is used for a nitride etching process that selectively etches an SiN film formed on an SiO₂ film, etc., by selecting a sufficiently low power bias.

Among the compounds shown by CHₚF₄₋ₚ, CHF₃ gas has a selectivity ratio of an SiN film to an SiO₂ film (SiN film etching rate/SiO₂ film etching rate) of 5 or less, and CH₂F₂ gas has a selectivity ratio of an SiN film to an SiO₂ film of 10 or less.

Patent Document 2 discloses a method that etches an SiN film that covers an SiO₂ film formed on an etching target placed in a chamber by generating plasma in the chamber using an etching gas, wherein a mixed gas prepared by mixing CH₃F gas and O₂ gas in a mixing ratio (O₂/CH₃F) of 4 to 9 is used as the etching gas.

However, since the size and the thickness of devices have been reduced in the field of device processing, a satisfactory selectivity ratio of an SiN film to an SiO₂ film and a satisfactory etching rate may not be achieved when using a gas of a compound shown by CHₚF₄₋ₚ (e.g., CHF₃, CH₂F₂, and CH₃F).

Therefore, development of an etching gas that can etch an SiN film with high selectivity as compared with an SiO₂ film and can achieve a high plasma etching rate has been desired.

### Patent Document 1: JP-A-8-059215

### Patent Document 2: JP-A-2003-229418 (US-A-2003-0121888)

### DISCLOSURE OF THE INVENTION

### Problems to be Solved by the Invention

The present invention was conceived in view of the above situation. An object of the present invention is to provide a plasma etching method that can selectivity etch a silicon nitride film at a high etching rate as compared with a silicon oxide film when etching a silicon nitride film that covers a silicon oxide film formed on the etching target.

### Means for Solving the Problems

The inventors of the present invention found that a plasma etching method that etches an etching target under plasma conditions using a process gas that includes a specific saturated fluorohydrocarbon, can selectivity etch a silicon nitride film at a high etching rate as compared with a silicon oxide film when etching a silicon nitride film that covers a silicon oxide film formed on the etching target.

Accordingly, the present invention provides the following plasma etching method (see (1) to (5)).

(1) A plasma etching method comprising etching an etching target under plasma conditions using a process gas, the process gas including a saturated fluorohydrocarbon shown by the formula (1): CₓH_{y}F_{z}, wherein x is 3, 4, or 5, and y and z are individually positive integers, provided that y>z is satisfied.
(2) The plasma etching method according to (1), wherein the process gas further includes oxygen gas and/or nitrogen gas.
(3) The plasma etching method according to (1) or (2), wherein the process gas further includes at least one gas selected from the group consisting of helium, argon, neon, krypton, and xenon.
(4) The plasma etching method according to any one of (1) to (3), the method being used to etch a silicon nitride film.
(5) The plasma etching method according to any one of (1) to (3), the method being used to selectively etch a silicon nitride film as compared with a silicon oxide film.

### Effects of the Invention

The present invention thus makes it possible to selectively etch a silicon nitride film at a high etching rate as compared with a silicon oxide film when etching a silicon nitride film that covers a silicon oxide film formed on the etching target, by providing a plasma etching method that etches the etching target under plasma conditions using a process gas that includes a specific saturated fluorohydrocarbon.

### BEST MODE FOR CARRYING OUT THE INVENTION

The present invention is described in detail below.

A plasma etching method according to one embodiment of the present invention includes etching an etching target under plasma conditions using a process gas, the process gas including a saturated fluorohydrocarbon shown by the formula (1): CₓH_{y}F_{z}, wherein x is 3, 4, or 5, and y and z are individually positive integers, provided that y>z is satisfied.

Since the plasma etching method according to one embodiment of the present invention utilizes the process gas that includes the saturated fluorohydrocarbon shown by the formula (1), the etching selectivity ratio of a silicon nitride film to a silicon oxide film can be increased (i.e., the etching rate can be increased).

Note that the etching selectivity ratio of a silicon nitride film to a silicon oxide film refers to the ratio of the average etching rate of a silicon nitride film to the average etching rate of a silicon oxide film ((average etching rate of silicon nitride film)/(average etching rate of silicon oxide film)). A high etching selectivity ratio of a silicon nitride film to a silicon oxide film may be referred to as having etch selectivity of silicon oxide film.

Since the saturated fluorohydrocarbon shown by the formula (1) has etch selectivity of silicon oxide film, a silicon nitride film can be efficiently etched (i.e., the etching rate can be increased) without damaging a silicon oxide film.

The term “etching” used herein refers to etching a highly integrated fine pattern on an etching target that is used in a semiconductor device production process, etc. The term “plasma etching” used herein refers to causing a glow discharge to occur by applying a high-frequency electric field to a process gas (reactive plasma gas), effecting etching by utilizing chemical reactions whereby gaseous compounds are decomposed into chemically active ions, electrons, and radicals.

In the formula (1), x is 3, 4, or 5, preferably 4 or 5, and particularly preferably 4, from the viewpoint of the balance between the silicon nitride film selectivity and the productivity (etching rate).

y and z are individually positive integers, provided that y>z is satisfied.

The fluorohydrocarbon shown by the formula (1) may have a chain structure or a cyclic structure insofar as x, y, and z in the formula (1) satisfy the above conditions. It is preferable that the fluorohydrocarbon shown by the formula (1) have a chain structure from the viewpoint of the balance between the silicon nitride film selectivity and the productivity (etching rate).

Specific examples of the fluorohydrocarbon shown by the formula (1) include

saturated fluorohydrocarbons shown by C₃H₇F, such as 1-fluoropropane and 2-fluoropropane; saturated fluorohydrocarbons shown by C₃H₆F₂, such as 1,1-difluoropropane, 1,2-difluoropropane, 1,3-difluoropropane, and 2,2-difluoropropane; saturated fluorohydrocarbons shown by C₃H₅F₃, such as 1,1,1-trifluoropropane, 1,1,1-trifluoropropane, 1,1,2-trifluoropropane, 1,2,2-trifluoropropane, and 1,1,3-trifluoropropane; saturated fluorohydrocarbons shown by C₄H₉F, such as 1-fluoro-n-butane and 1,1-difluoro-n-butane;
saturated fluorohydrocarbons shown by C₄H₈F₂, such as 1,1-difluoro-n-butane, 1,2-difluoro-n-butane, 1,2-difluoro-2-methylpropane, 2,3-difluoro-n-butane, 1,4-difluoro-n-butane, 1,3-difluoro-2-methylpropane, 2,2-difluoro-n-butane, 1,3-difluoro-n-butane, 1,1-difluoro-2-methylpropane, and 1,4-difluoro-n-butane;
saturated fluorohydrocarbons shown by C₄H₇F₃, such as 1,1,1-trifluoro-n-butane, 1,1,1-trifluoro-2-methylpropane, 2,2,2-trifluoromethylpropane, 1,1,2-ttifluoro-n-butane, 1,1,3-trifluoro-n-butane, and 1,1,4-trifluoro-n-butane;
saturated fluorohydrocarbons shown by C₄H₆F₄, such as 1,1,1,4-tetrafluoro-n-butane, 1,2,3,4-tetrafluoro-n-butane, 1,1,1,2-tetrafluoro-n-butane, 1,2,3,3-tetrafluoro-n-butane, 1,1,3,3-tetrafluoro-2-methylpropane, 1,1,3,3-tetrafluoro-n-butane, 1,1,1,3-tetrafluoro-n-butane, 1,1,2,2-tetrafluoro-n-butane, 1,1,2,3-tetrafluoro-n-butane, 1,2,2,3-tetrafluoro-n-butane, 1,1,3-trifluoro-2-fluoromethylpropane, 1,1,2,3-tetrafluoro-2-methylpropane, 1,2,3,4-tetrafluoro-n-butane, 1,1,2,4-tetrafluoro-n-butane, 1,2,2,4-tetrafluoro-n-butane, 1,1,4,4-tetrafluoro-n-butane, 1,2,3-trifluoro-2-fluoromethylpropane, 1,1,1,2-tetrafluoro-2-methylpropane, 1,1,3,4-tetrafluoro-n-butane, and 2,2,3,3-tetrafluoro-n-butane;
saturated fluorohydrocarbons shown by C₅H₁₁F, such as 1-fluoro-n-pentane, 2-fluoro-n-pentane, 3-fluoro-n-pentane, 1-fluoro-2-methyl-n-butane, and 1-fluoro-2,3-dimethylpropane; saturated fluorohydrocarbons shown by C₅H₁₀F₂, such as 1,1-difluoro-n-pentane, 1,2-difluoro-n-pentane, 1,3-difluoro-n-pentane, 1,5-difluoro-n-pentane, 1,1-difluoro-2-methyl-n-butane, and 1,2-difluoro-2,3-dimethylpropane; saturated fluorohydrocarbons shown by C₅H₉F₃, such as 1,1,1-trifluoro-n-pentane, 1,1,2-trifluoro-n-pentane, 1,1,3-trifluoro-n-pentane, 1,1,5-tifluoro-n-pentane, 1,1,1-trifluoro-2-methyl-n-butane, 1,1,2-trifluoro-2,3-dimethylpropane, and 2-trifluoromethyl-n-butane;
saturated fluorohydrocarbons shown by C₅H₈F₄, such as 1,1,1,2-tetrafluoro-n-pentane, 1,1,2,2-tetrafluoro-n-pentane, 1,1,2,3-tetrafluoro-n-pentane, 1,1,3,3-tetrafluoro-n-pentane, 1,1,4,4-tetrafluoro-2-methyl-n-butane, 1,1,2,3-tetrafluoro-2,3-dimethylpropane, and 1-fluoro-2-trifluoromethyl-n-butane; saturated fluorohydrocarbons shown by C₅H₇F₅, such as 1,1,1,2,2-pentafluoro-n-pentane, 1,1,2,2,2-pentafluoro-n-pentane, 1,1,1,2,3-pentafluoro-n-pentane, 1,1,3,5,5-pentafluoro-n-pentane, 1,1,1,4,4-pentafluoro-2-methyl-n-butane, 1,1,1,2,3-tetrafluoro-2,3-dimethylpropane, and 1,5-difluoro-2-trifluoromethyl-n-butane;
fluorocyclobutane (C₄H₇F); cyclic saturated fluorohydrocarbons shown by C₄H₆F₂, such as 1,1-difluorocyclobutane, 1,2-difluorocyclobutane, and 1,3-difluorocyclobutane; cyclic saturated fluorohydrocarbons shown by C₄H₅F₃, such as 1,1,2-trifluorocyclobutane, 1,1,3-trifluorocyclobutane, 1,2,3-trifluorocyclobutane;
fluorocyclopentane (C₅H₉F); cyclic saturated fluorohydrocarbons shown by C₅H₈F₂, such as 1,1-difluorocyclopentane, 1,2-difluorocyclopentane, and 1,3-difluorocyclopentane; cyclic saturated fluorohydrocarbons shown by C₅H₇F₃, such as 1,1,2-trifluorocyclopentane, 1,1,3-trifluorocyclopentane, and 1,2,3-trifluorocyclopentane; cyclic saturated fluorohydrocarbons shown by C₅H₆F₄, such as 1,1,2,2-tetrafluorocyclopentane, 1,1,2,3-tetrafluorocyclopentane, 1,2,2,3-tetrafluorocyclopentane, and 1,2,3,4-tetrafluorocyclopentane; fluorocyclohexane (C₆H₁₁F); cyclic saturated fluorohydrocarbons shown by C₆H₁₀F₂, such as 1,1-difluorocyclohexane, 1,3-difluorocyclohexane, and 1,4-difluorocyclohexane; cyclic saturated fluorohydrocarbons shown by C₆H₉F₃, such as 1,1,2-trifluorocyclohexane, 1,1,3-trifluorocyclohexane, and 1,1,4-trifluorocyclohexane;
cyclic saturated fluorohydrocarbons shown by C₆H₈F₄, such as 1,1,2,2-tetrafluorocyclohexane, 1,1,3,3-tetrafluorocyclohexane, 1,1,4,4-tetrafluorocyclohexane, 1,1,2,3-tetrafluorocyclohexane, 1,1,2,4-tetrafluorocyclohexane, and 1,1,3,4-tetrafluorocyclohexane; cyclic saturated fluorohydrocarbons shown by C₆H₇F₅, such as 1,1,2,2,3-pentafluorocyclohexane, 1,1,2,2,4-pentafluorocyclohexane, and 1,1,2,4,4-pentafluorocyclohexane; and the like.

These fluorohydrocarbons shown by the formula (1) may be used either individually or in combination. It is preferable to use one type of fluorohydrocarbon so that the effect of the present invention is achieved more significantly.

Many of the fluorohydrocarbons shown by the formula (1) are known compounds, and may be prepared by a known method.

For example, the fluorohydrocarbons may be produced by the method disclosed in Journal of the American Chemical Society (1942), 64, 2289-92, Journal of Industrial and Engineering Chemistry (1947), 39, 418-20, etc.

A commercially available fluorohydrocarbon may also be used either directly or after purification.

For example, the fluorohydrocarbon shown by the formula (1) is introduced into an arbitrary container (e.g., cylinder) in the same manner as a semiconductor process gas, and is used for plasma etching described later.

The purity of the fluorohydrocarbon (gas) shown by the formula (1) is preferably 99 vol % or more, more preferably 99.9 vol % or more, and particularly preferably 99.98 vol % ore more. If the purity of the fluorohydrocarbon shown by the formula (1) is within the above range, the effect of the present invention is improved. If the purity of the fluorohydrocarbon shown by the formula (1) is too low, the purity of gas (i.e., the fluorohydrocarbon shown by the formula (1)) may become non-uniform inside the container that is filled with the gas. Specifically, the purity of gas may significantly differ between the initial stage and a stage when the amount of gas has decreased.

In this case, a large difference in plasma etching performance may occur between the initial stage and a stage when the amount of gas has decreased, so that yield may decrease during industrial production. The purity of gas does not become non-uniform inside the container by increasing the purity of gas (i.e., a difference in plasma etching performance does not occur between the initial stage and a stage when the amount of gas has decreased), so that the gas can be efficiently utilized.

Note that the content (purity) of the fluorohydrocarbon shown by the formula (1) refers to a purity by volume derived from the weight percentage (%) determined by gas chromatography using the internal standard method.

An etching gas is normally prepared by appropriately mixing an oxygen gas, a nitrogen gas, etc., with the fluorohydrocarbon shown by the formula (1) (described later).

The fluorohydrocarbon shown by the formula (1) may include impurities such as air, a nitrogen gas in production facilities, a solvent used during production, and water derived from hygroscopic salts and alkali.

When nitrogen gas, oxygen gas, etc., are present in the fluorohydrocarbon contained in the container, the amount of gas mixed must be adjusted taking account of the amount of such a gas. This is because nitrogen gas, oxygen gas, water, etc., significantly affect a plasma reaction of the fluorohydrocarbon shown by the formula (1) that dissociates in a plasma reactor and produces various free radicals (etching species).

Moreover, when nitrogen gas, oxygen gas, water, etc., are present in a container that is filled with the fluorohydrocarbon, the composition of the fluorohydrocarbon shown by the formula (1) and impurities discharged from the container differs between the time immediately after the container is opened and the time when the amount of the fluorohydrocarbon contained in the container has decreased.

Therefore, when the amount of nitrogen gas, oxygen gas, water, etc., contained in the fluorohydrocarbon shown by the formula (1) increases, a stable plasma reaction cannot be obtained under normal conditions without accurately adjusting the amount of gas mixed.

The total amount of oxygen gas and nitrogen gas included in the fluorohydrocarbon shown by the formula (1) as residual trace gas is preferably 200 ppm by volume or less, more preferably 150 ppm by volume or less, and particularly preferably 100 ppm by volume or less. The water content in the fluorohydrocarbon shown by the formula (1) is preferably 30 ppm by weight or less, more preferably 20 ppm by weight or less, and particularly preferably 10 ppm by weight or less.

The total amount of oxygen gas and nitrogen gas refers to the content (ppm) by volume of oxygen gas and nitrogen gas determined by gas chromatography using the absolute calibration method. The volume basis is equivalent to the molar basis. The water content normally refers to a water content (ppm) by weight determined by the Karl Fisher method.

The process gas used in the present invention preferably further includes oxygen gas and/or nitrogen gas in addition to the fluorohydrocarbon shown by the formula (1). The selectivity ratio can be significantly increased by utilizing oxygen gas and/or nitrogen gas in addition to the fluorohydrocarbon shown by the formula (1) while preventing an etching stop phenomenon that is considered to occur due to accumulation of reaction products at the hole bottom. In the plasma etching method according to one embodiment of the present invention, the selectivity ratio of an SiN film to an SiO₂ film (SiN film/SiO₂ film) is 10 or more, and preferably 20 or more.

The volume ratio of oxygen gas, nitrogen gas, or oxygen gas and nitrogen gas to the fluorohydrocarbon shown by the formula (1) is preferably 0.1 to 50, and more preferably 0.5 to 30.

It is preferable that the process gas further include at least one Group 18 gas selected from the group consisting of helium, argon, neon, krypton, and xenon. The SiN film etching rate can be improved by utilizing the Group 18 gas while maintaining the selectivity ratio.

The volume ratio of the Group 18 gas to the fluorohydrocarbon shown by the formula (1) is preferably 0 to 100, and more preferably 0 to 20.

The process gas is supplied (introduced) at a rate proportional to the amount of each component. For example, the fluorohydrocarbon shown by the formula (1) is supplied at 8×10⁻³ to 5×10⁻² Pa·m³/sec, oxygen gas is supplied at 8×10⁻² to 5×10⁻¹ Pa·m³/sec, and the Group 18 gas is supplied at 8×10⁻² to 5×10⁻¹ Pa·m³/sec.

The pressure inside the chamber into which the process gas has been introduced is normally 0.0013 to 1300 Pa, and preferably 0.13 to 13 Pa.

When applying a high-frequency electric field to the fluorohydrocarbon shown by the formula (1) (reactive plasma gas) contained in the chamber using a plasma generator, a glow discharge occurs so that plasma is generated.

Examples of the plasma generator include a helicon wave plasma generator, a high-frequency induction plasma generator, a parallel plate plasma generator, a magnetron plasma generator, a microwave plasma generator, and the like. It is preferable to use a helicon wave plasma generator, a high-frequency induction plasma generator, or a microwave plasma generator from the viewpoint of ease of high-density plasma generation.

The plasma density is not particularly limited. It is preferable to etch the etching target in a high-density plasma atmosphere with a plasma density of preferably 10¹¹ ions/cm³ or more, and more preferably 10¹² to 10¹³ ions/cm³, in order to advantageously achieve the effect of the present invention.

The temperature of the etching target substrate that is reached during etching is not particularly limited, but is preferably 0 to 300° C., more preferably 0 to 100° C., and still more preferably 20 to 80° C. The temperature of the substrate may or may not be controlled by cooling, etc.

The etching time is normally 5 to 10 minutes. Since the process gas used in one embodiment of the present invention enables high-speed etching, the productivity can be improved by setting the etching time to 2 to 5 minutes.

The plasma etching method according to one embodiment of the present invention generates plasma in a chamber using the process gas (etching gas) that includes the fluorohydrocarbon shown by the formula (1), and etches a given area of the etching target placed inside the chamber. The plasma etching method according to one embodiment of the present invention preferably selectively plasma-etches a silicon nitride film, and more preferably selectively plasma-etches a silicon nitride film with respect to a silicon oxide film.

A selectivity ratio of a silicon nitride film to a silicon oxide film of 10 or more (20 or more in many cases) is achieved by etching a silicon nitride film under the above etching conditions, so that a significantly high selectivity ratio can be obtained as compared with a known method while preventing an etching stop phenomenon due to accumulated products. This makes it possible to prevent a situation in which a silicon oxide film (SiO₂ film) breaks during etching a silicon nitride film, even if the thickness of a silicon oxide film included in a device is reduced. Therefore, only a silicon nitride film can be reliably etched, so that a device that exhibits excellent electrical properties can be produced.

The plasma etching method according to one embodiment of the present invention may be applied (a) when forming a mask pattern so that a given area of an ONO film (silicon oxide film-silicon nitride film-silicon oxide film) is exposed, etching the ONO film via the mask pattern to remove at least the upper silicon oxide film, and selectively etching the exposed silicon nitride film, and (b) when forming a thin silicon nitride film (e.g., 10 to 20 nm) on the side wall (inner wall) of a contact hole, and etching away the silicon nitride film that is positioned at the bottom of the contact hole in order to protect the interlayer dielectric (oxide film) against damage, etc.

### EXAMPLES

The present invention is further described below by way of examples. Note that the present invention is not limited to the following examples. In the following examples, the unit “parts” refers to “parts by weight” unless otherwise indicated.

The content of the fluorohydrocarbon shown by the formula (1) in the process gas was determined by gas chromatography (GC).

The following GC conditions were used.

Equipment: HP6890 manufactured by Hewlett-Packard
Column: NEUTRA BOND-1 (length: 60 m, ID: 250 μm, film: 1.50 μm)

### Detector: FID

Injection temperature: 150° C.
Detector temperature: 250° C.
Carrier gas: nitrogen gas (23.2 ml/min)
Make-up gas: nitrogen gas (30 ml/min), hydrogen gas (50 ml/min), air (400 ml/min)
Split ratio: 137/1
Heating program: (1) maintained at 40° C. for 20 min, (2) heated at 40° C./min, and (3) maintained at 250° C. for 14.75 min

Each of a wafer on which an SiN film was formed and a wafer on which an SiO₂ film was formed was etched using the etching method according to the present invention. The SiN film etching rate and the SiO₂ film etching rate were measured, and the selectivity ratio (SiN film/SiO₂ film) was calculated from the ratio of the SiN film etching rate to the SiO₂ film etching rate based on the measurement results.

2,2-Difluoro-n-butane was used as the fluorohydrocarbon shown by the formula (1).

The wafer on which an SiN film was formed or the wafer on which an SiO₂ film was formed was placed in an etching chamber of a parallel plate plasma etching apparatus. After evacuating the system, the wafer was etched under the following etching conditions. The SiN film was etched at an etching rate of 64 nm/min. On the other hand, the SiO₂ film was not etched (i.e., the selectivity ratio was infinite).

Etching conditions
Pressure of mixed gas: 75 mTorr (10 Pa)
Power supplied to upper electrode from high-frequency power supply: 100 W
Power supplied to lower electrode from high-frequency power supply: 100 W
Interval between upper electrode and lower electrode: 50 mm
Gas flow rate:
Ar gas: 1.69×10⁻¹ Pa·m³/sec
O₂ gas: 1.69×10⁻¹ Pa·m³/sec
Fluorohydrocarbon gas: 3.38×10⁻² Pa·m³/sec (flow ratio: Ar/O₂/fluorohydrocarbon=100/100/20)
Electrode temperature: 20° C.

### Comparative Example

An etching process was performed in the same manner as in the Example, except for using a CH₃F gas as the fluorohydrocarbon. The SiN film etching rate was 56 nm/min, and the SiO₂ film etching rate was 2 nm/min (selectivity ratio: 28).

1. A plasma etching method comprising etching an etching target under plasma conditions using a process gas, the process gas including a saturated fluorohydrocarbon shown by the formula (1): CₓH_{y}F_{z}, wherein x is 3, 4, or 5, and y and z are individually positive integers, provided that y>z is satisfied.

2. The plasma etching method according to claim 1, wherein the process gas further includes oxygen gas and/or nitrogen gas.

3. The plasma etching method according to claim 1, wherein the process gas further includes at least one gas selected from the group consisting of helium, argon, neon, krypton, and xenon.

4. The plasma etching method according to claim 1, the method being used to etch a silicon nitride film.

5. The plasma etching method according to claim 1, the method being used to selectively etch a silicon nitride film as compared with a silicon oxide film.

6. The plasma etching method according to claim 2, wherein the process gas further includes at least one gas selected from the group consisting of helium, argon, neon, krypton, and xenon.

7. The plasma etching method according to claim 2, the method being used to etch a silicon nitride film.

8. The plasma etching method according to claim 3, the method being used to etch a silicon nitride film.

9. The plasma etching method according to claim 6, the method being used to etch a silicon nitride film.

10. The plasma etching method according to claim 2, the method being used to selectively etch a silicon nitride film as compared with a silicon oxide film.

11. The plasma etching method according to claim 3, the method being used to selectively etch a silicon nitride film as compared with a silicon oxide film.

12. The plasma etching method according to claim 6, the method being used to selectively etch a silicon nitride film as compared with a silicon oxide film.
